(19) United States
(12) Patent Application Publication
(10) Pub. No.: US 2005/0275760 A1
(43) Pub. Date: Dec. 15, 2005

(54) Modifying a rasterized surface, such as by trimming

(75) Inventors: Larry I. Gritz, Berkeley, CA (US); Daniel Elliott Wexler, Soda Springs, CA (US)

Correspondence Address: BERKELEY LAW & TECHNOLOGY GROUP, 1700NW 167TH PLACE, SUITE 240, BEAVERTON, OR, 97006, US

(73) Assignee: NVIDIA Corporation, Santa Clara, CA (US)

(21) Appl. No.: 10/792,497

(22) Filed: Mar. 2, 2004

(51) Int. Cl. H04N 3/23

(52) U.S. Cl. 348/746

(57) ABSTRACT

Embodiments of methods, apparatuses, devices, and/or systems for modifying a rasterized surface, such as by trimming, for graphics and/or video processing, for example, are described.

### BACKGROUND

This disclosure is related to modifying a rasterized surface, such as for graphics and/or video processing, for example.

Computer graphics is an extensive field in which a significant amount of hardware and software development has taken place over the last twenty years or so. See, for example, Computer Graphics: Principles and Practice, by Foley, Van Dam, Feiner, and Hughes, published by Addison-Wesley, 1997. Typically, in a computer platform or other similar computing device, dedicated graphics hardware is employed in order to render graphical images, such as those used in connection with computer games, for example. For such systems, dedicated graphics hardware may be limited in a number of respects that have the potential to affect the quality of the graphics, including hardware flexibility and/or its rendering capability.

One issue that relates to graphics quality is the rendering of trimmed surfaces. In one approach, trimmed Non-uniform Rational B-spline (NURB) surfaces are rendered with Adaptive Forward Differencing. See “Rendering Trimmed NURBS with Adaptive Forward Differencing,” by Shantz and Chang, Computer Graphics, Vol. 22, No. 4, August 1988, pp 189-198. In this approach, adaptive forward differencing is extended to higher order, the basis matrix for each scan is computed, the shading approximation function for rational surfaces is calculated, and the NURB surfaces are trimmed and image mapped. Trimming is accomplished by using AFD to scan convert the trimming curves in parameter space, producing the intersection points between the trim curves and an isoparametric curve along the surface. A winding rule is used to determine the regions bounded by the curve which are then rendered with AFD. In another approach, all trimmed surfaces are converted into individual Bezier patches with trimming regions defined by closed loops of Bezier or piecewise linear curves. Step sizes are calculated in parameter space for each curve and surface which guarantee the size of facets in screen space will not exceed a user specified tolerance. All points on the trimming curves where the tangents are parallel to the u or v axes are discovered, here, the local minima and maxima. Using the extremes, the trimming region of the patch is divided into u,v-monotone regions. Each region is defined by a closes loop of curves. Using the calculated step sizes, each u,v-monotone region is uniformly tessellated into a grid of rectangles connected by triangles to points evaluated along the curves. The polygons defined in u,v parameter space are transformed into facets in object space by evaluating their vertices with the surface factions. Surface normals are also calculated. Each facet is transformed to screen space, clipped, lighted, smooth shaded and z-buffered using 3D graphics hardware. See “Real-Time Rendering of Trimmed Surfaces,” by Rockwood, Heaton, and Davis, Computer Graphics, Vol. 23, No. 3, July 1989, pp 107-116.

However, higher quality graphics continues to be desirable as the technology and the marketplace continues to evolve. Thus, signal processing and/or other techniques to extend the capability of existing hardware in terms of the quality graphics that may be produced continues to be an area of investigation.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference of the following detailed description when read with the accompanying drawings in which:

FIG. 1 is block diagram illustrating an embodiment of a typical graphics pipeline;

FIG. 2 is a schematic diagram of an embodiment of a computer platform that includes dedicated graphics hardware, such as a programmable GPU;

FIG. 3 is a flowchart illustrating an embodiment of a method of modifying a rasterized surface;

FIG. 4 is a block diagram illustrating an embodiment of a typical programmable vertex shader;

FIG. 5 is a block diagram illustrating an embodiment of a typical programmable fragment processing stage;

FIG. 6 is a schematic diagram illustrating another embodiment of a computer platform;

FIG. 7 is a schematic diagram illustrating one embodiment of a technique for modifying a rasterized surface; and

FIG. 8 is a schematic diagram illustrating an embodiment of a method of modifying a rasterized surface.

### SUMMARY

Embodiments of methods, apparatuses, devices, and/or systems for modifying a rasterized surface, such as for graphics and/or video processing, for example, are described. For example, in accordance with one embodiment, a method of modifying a rasterized surface using dedicated graphics hardware is as follows. One or more trim regions are loaded in texture memory in a parameter space of the surface. A surface is rasterizied using said dedicated graphics hardware. Portions of the rasterized surface are modified based at least in part on the one or more trim regions.

### DETAILED DESCRIPTION

In the following detailed description, numerous specific details are set forth to provide a thorough understanding of the claimed subject matter. However, it will be understood by those skilled in the art that the claimed subject matter may be practiced without these specific details. In other instances, well-known methods, procedures, components and/or circuits have not been described in detail so as not to obscure the claimed subject matter.

Computer graphics is an extensive field in which a significant amount of hardware and software development has taken place over the last twenty years or so. See, for example, Computer Graphics: Principles and Practice, by Foley, Van Dam, Feiner, and Hughes, published by Addison-Wesley, 1997. Typically, in a computer platform or other similar computing device, dedicated graphics hardware is employed in order to render graphical images, such as those used in connection with computer games, for example. For such systems, dedicated graphics hardware may be limited in a number of respects that have the potential to affect the quality of the graphics, including hardware flexibility and/or its rendering capability. However, higher quality graphics continues to be desirable as the technology and the marketplace continues to evolve. Thus, signal processing and/or other techniques to extend the capability of existing hardware in terms of the quality graphics that may be produced continues to be an area of investigation.

As previously discussed, dedicated graphics hardware may be limited in its capabilities, such as its graphics rendering capabilities and/or its flexibility. This may be due at least in part, for example, to the cost of hardware providing improved abilities relative to the demand for such hardware. Despite this, however, in recent years, the capabilities of dedicated graphics hardware provided on state-of-the-art computer platforms and/or similar computing systems have improved and continue to improve. For example, fixed function pipelines have been replaced with programmable vertex and fragment processing stages. As recently as 6 years ago, most consumer three-dimensional (3D) graphics operations were principally calculated on a CPU and the graphics card primarily displayed the result as a frame buffer. However, dedicated graphics hardware has evolving into a graphics pipeline comprising tens of millions of transistors. Today, a programmable graphics processing unit (GPU) is capable of more than simply feed-forward triangle rendering. State-of-the art graphics chips, such as the NVIDIA GeForce FX and the ATI Radon 9000, for example, replace fixed-function vertex and fragment processing stages with programmable stages, as described in more detail hereinafter. These programmable vertex and fragment processing stages have the capability to execute programs allowing control over shading and/or texturing calculations, as described in more detail hereinafter.

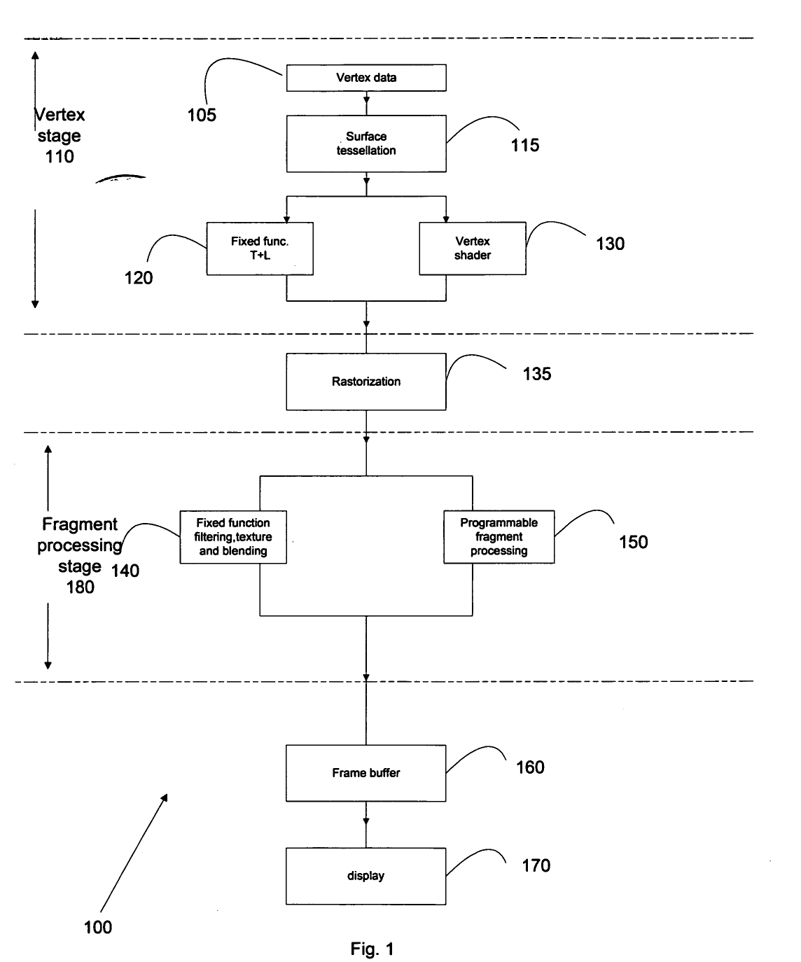

Similar to CPU architectures, a GPU may be broken down into pipeline stages. However, whereas a CPU embodies a general purpose design used to execute arbitrary programs, a GPU is architected to process raw geometry data and eventually represent that information as pixels on a display, such as a monitor, for example. FIG. 1 is a block diagram conceptualization of a typical graphics pipeline.

Typically, for an object to be drawn, the following operations are executed by such a pipeline:

1. An application executing on a CPU may instruct a GPU where to find vertex data, such as 105, within a portion of memory.

2. Vertex stage 110 may transform the vertex data from model space to clip space and may perform lighting calculations, etc.

3. Vertex stage 110 may generate texture coordinates from mathematical formulae.

4. Primitives, such as triangle, points, quadrangles, and the like, may be rasterized into fragments.

5. Fragment color may be determined by processing fragments through fragment processing stage 180, which may also perform, among other operations, texture memory look-ups.

6. Some tests may be performed to determine if fragments should be discarded.

7. Pixel color may be calculated based at least in part on fragment color and other operations typically involving fragments' or pixels' alpha channel.

8. Pixel information may be provided to frame buffer 160.

9. Pixels may be displayed, such as by display 170.

As illustrated by block 115 of FIG. 1, higher order surface tessellation occurs early in the geometry processing phase of a graphics pipeline. Higher-order surfaces use mathematical formulae and/or functions to represent three-dimensional (3D) surfaces. Examples include Non-uniform Rational B-splines (NURBs), Bezier curves, N-patches, and more. The data transferred is tessellated to generate more complex models. The GPU, therefore, dynamically generates or tessellates the primary model data from the application into much more detailed and complex geometry.

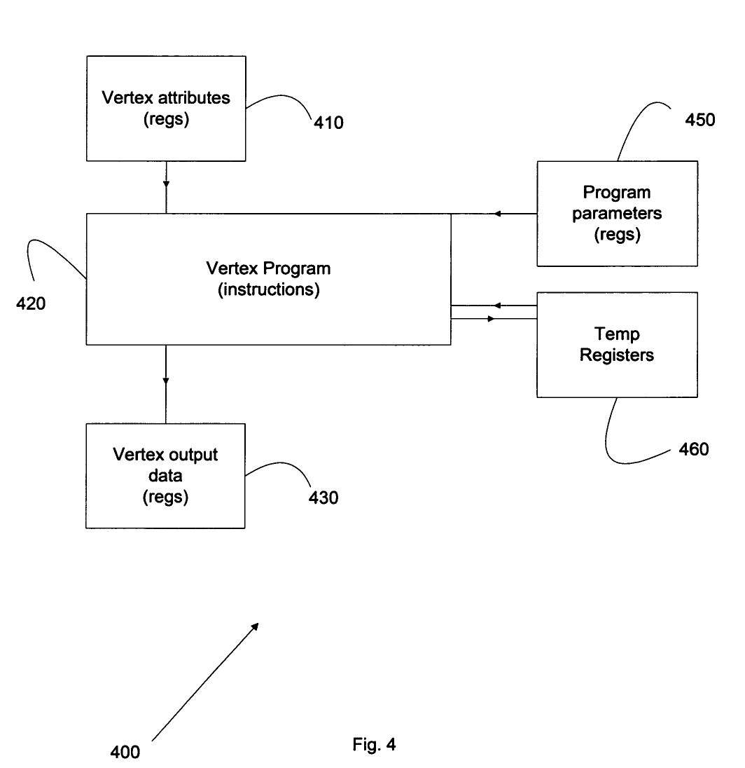

As illustrated by block 120 and previously suggested, a graphics pipeline typically will perform transform and lighting (T & L) operations and the like. Block 120 depicts a fixed-function unit; however, these operations are being replaced more and more by programmable vertex units, such as 130, also referred to as vertex shaders. Vertex shader 130 applies a vertex program to a stream of vertices. Therefore, the program processes data at the vertex level. Most operations are performed in one cycle, although this restriction need not apply. A typical vertex program is on the order of a hundred or more instructions. FIG. 4 is a block diagram illustrating an embodiment of a typical programmable vertex shader. As illustrated, vertex attributes 410 are applied to vertex program 420. The attributes are stored in registers and the program comprises a series of instructions that process the data in the registers. The resulting processed data, illustrated in FIG. 4 as vertex output data 430, is also stored in registers. Typically, while the program is executing, it will obtain program parameters, illustrated by 450 in FIG. 4, and it will utilize temporary registers, illustrated by 460 in FIG. 4.

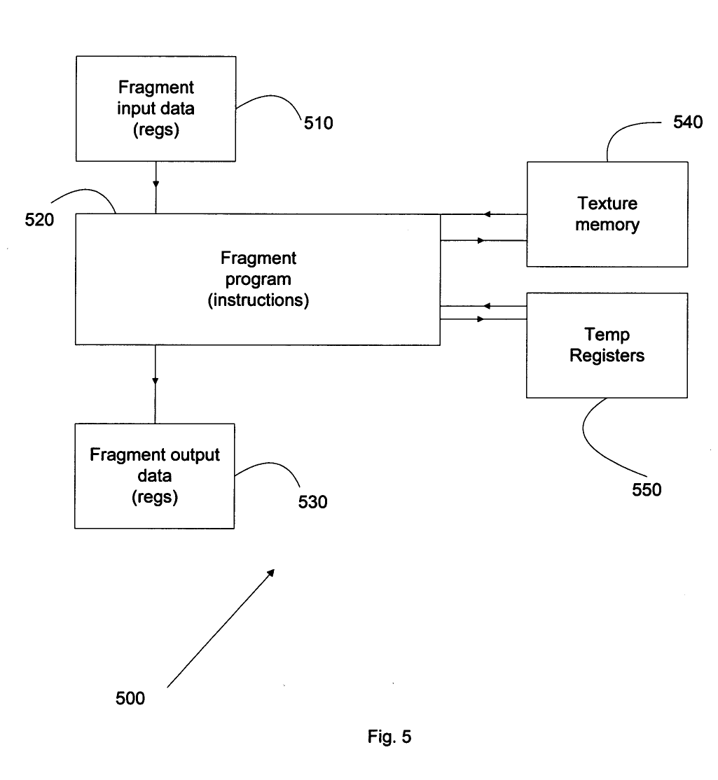

As with the vertex stage, the fragment processing stage has undergone an evolution from a fixed function unit, such as illustrated by block 140, to a programmable unit, such as illustrated by block 150. Thus, previously, texturing, filtering and blending were performed using fixed function state machines or similar hardware. As with vertex shaders, a pixel shader, such as 150, also referred to as a programmable fragment processing stage, permits customized programming control. Therefore, on a per pixel basis, a programmer is able to compute color and the like to produce desired customized visual effects. FIG. 5 is a block diagram illustrating an embodiment of a typical pixel shader or fragment processing stage. Similar to its counterpart in the vertex stage, embodiment 500 includes fragment input data 510, fragment program 520, and fragment output data 530. Likewise, this stage includes texture memory 540 and temporary registers 550. In this context, texture memory refers to a memory portion of the GPU included as part of a fragment processing stage, typically cache memory, where, following the execution of vertex processing and the like, particular pixel values may be loaded for additional processing, such as for filtering, shading, and/or similar processing, such as, for example, processing typically associated with creating the appearance of a visible surface of an object to be rendered.

These trends in programmability of the graphics pipeline have transformed the graphics processing unit (GPU) and its potential applications. Thus, one potential application of such a processor or processing unit is to accomplish high quality graphics processing, such as may be desirable for a variety of different situations, such as for creating animation and the like, for example. More specifically, in recent years, the performance of graphics hardware has increased more rapidly than that of central processing units (CPUs). As previously indicated, CPU designs are typically intended for high performance processing on sequential code. It is, therefore, becoming increasingly more challenging to use additional transistors to improve processing performance. In contrast, as just illustrated, programmable graphics hardware is designed for parallel processing of vertex and fragment stage code. As a result, GPUs are able to use additional transistors more effectively than CPUs to produce processing performance improvements. Thus, GPUs offer the potential to sustain processing performance improvements as semiconductor fabrication technology continues to advance.

Of course, programmability is a relatively recent innovation. Furthermore, a range of differing capabilities are included within the context of “programmability.” For the discussion of this particular embodiment, focus will be placed upon the fragment processing stage of the GPU rather than the vertex stage, although, of course, the claimed subject matter is not limited in scope in this respect. Thus, in one embodiment, a programmable GPU may comprise a fragment processing stage that has a simple instruction set. Fragment program data types may primarily comprise fixed point input textures. Output frame buffer colors may typically comprise eight bits per color component. Likewise, a stage typically may have a limited number of data input elements and data output elements, a limited number of active textures, and a limited number of dependent textures. Furthermore, the number of registers and the number of instructions for a single program may be relatively short. The hardware may only permit certain instructions for computing texture addresses only at certain points within the program. The hardware may only permit a single color value to be written to the frame buffer for a given pass, and programs may not loop or execute conditional branching instructions. In this context, an embodiment of a GPU with this level of capability or a similar level of capability shall be referred to as a fixed point programmable GPU.

In contrast, more advanced dedicated graphics processors or dedicated graphics hardware may comprise more enhanced features. The fragment processing stage may be programmable with floating point instructions and/or registers, for example. Likewise, floating point texture frame buffer formats may be available. Fragment programs may be formed from a set of assembly language level instructions capable of executing a variety of manipulations. Such programs may be relatively long, such as on the order of hundreds of instructions or more. Texture lookups may be permitted within a fragment program, and there may, in some embodiments, be no limits on the number of texture fetches or the number of levels of texture dependencies within a program. The fragment program may have the capability to write directly to texture memory and/or a stencil buffer and may have the capability to write a floating point vector to the frame buffer, such as RGBA, for example. In this context, an embodiment of a GPU with this level of capability or a similar level of capability may be referred to as a floating point programmable GPU.

Likewise, a third embodiment or instantiation of dedicated graphics hardware shall be referred to here as a programmable streaming processor. A programmable streaming processor comprises a processor in which a data stream is applied to the processor and the processor executes similar computations or processing on the elements of the data stream. The system may execute, therefore, a program or kernel by applying it to the elements of the stream and by providing the processing results in an output stream. In this context, likewise, a programmable streaming processor which focuses primarily on processing streams of fragments comprises a programmable streaming fragment processor. In such a processor, a complete instruction set and larger data types may be provided. It is noted, however, that even in a streaming processor, loops and conditional branching are typically not capable of being executed without intervention originating external to the dedicated graphics hardware, such as from a CPU, for example. Again, an embodiment of a GPU with this level of capability or a similar level comprises a programmable streaming processor in this context.

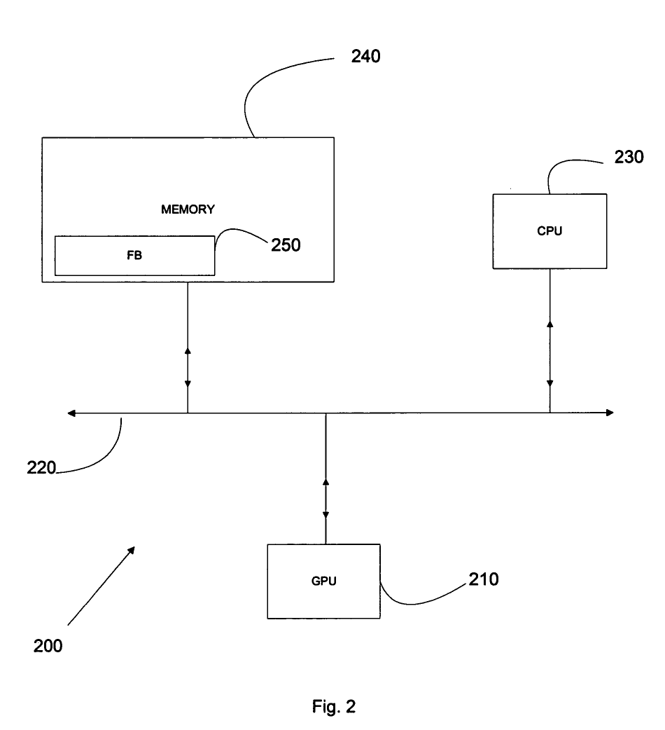

FIG. 2 is a schematic diagram illustrating an embodiment 200 comprising a system that may employ dedicated graphics hardware, such as, for example, GPU 210. It is noted that FIG. 2 is a simplified diagram for ease of discussion and illustration. Therefore, aspects such as a memory controller/arbiter, interface units to implement standard interface protocols, such as AGP and/or PCI, display devices, input devices, and the like have been omitted so as not to unnecessarily obscure the discussion.

In this particular embodiment, GPU 210 may comprise any instantiation of a programmable GPU, such as, for example, one of the three previously described embodiments, although for the purposes of this discussion, it is assumed that GPU 210 comprises a programmable floating point GPU. Likewise, it is, of course, appreciated that the claimed subject matter is not limited in scope to only the three types of GPUs previously described. These three are merely provided as illustrations of typical programmable GPUs. All other types of programmable GPUs currently known or to be developed later are included within the scope of the claimed subject matter. For example, while FIG. 2 illustrates discrete graphics hardware, alternatively, the graphics hardware may be integrated with the CPU on an IC and still remain within the scope of the claimed subject matter. Likewise, the applications of a system embodiment, such as the embodiment illustrated in FIG. 2, for example, include a host of possible applications, such as within or on: a desktop computing platform, a mobile computing platform, a handheld device, a workstation, a game console, a set-top box, a motherboard, a graphics card, and others.

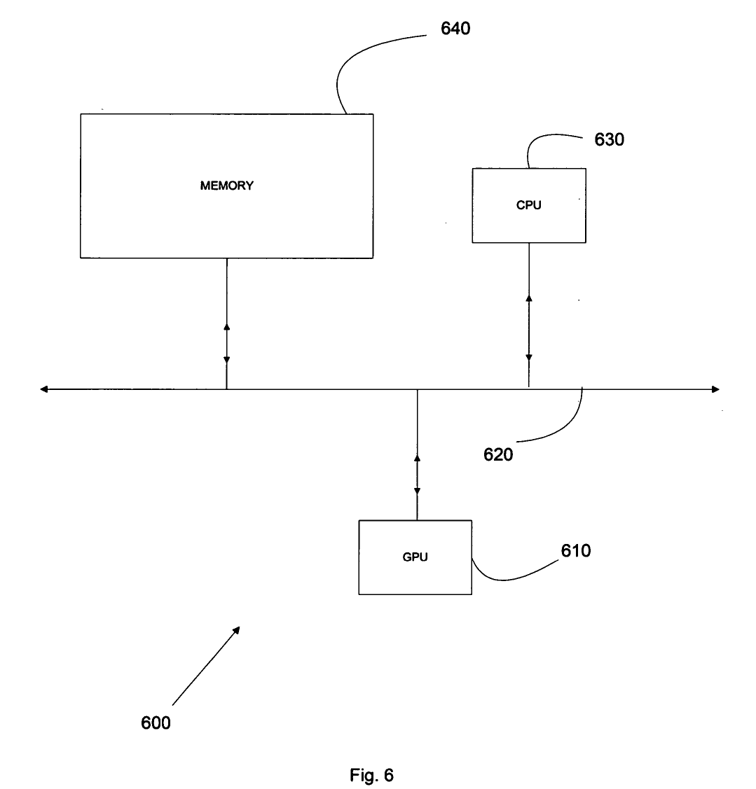

Likewise, for this simplified embodiment, system 200 comprises a CPU 230 and a GPU 210. In this particular embodiment, memory 240 comprises random access memory or RAM, although the claimed subject matter is not limited in scope in this respect. Any one of a variety of types of memory currently known or to be developed may be employed. It is noted that memory 240 includes frame buffer 250 in this particular embodiment, although, again, the claimed subject matter is not limited in scope in this respect. For example, FIG. 6 illustrates an embodiment where like reference numerals designate corresponding aspects. In embodiment 600, however, frame buffer 650 does not reside within memory 640. Communication between various system elements takes place via bus 220 in this particular embodiment, as is further illustrated in FIG. 2.

It is worth repeating that FIG. 2 is simply provided for purposes of illustration and is not intended to limit the scope of the claimed subject matter in any way. A multitude of architectures for a system that includes a GPU and a CPU is possible and the claimed subject matter is intended to encompass all such architectures. Although the claimed subject matter is not limited in scope to the embodiment illustrated in FIG. 2 just described, it is noted that this particular embodiment comprises a system employing two co-processors, CPU 230 and GPU 210. Thus, in at least this respect, this embodiment is typical of state-of-the art computing platforms. Thus, as previously described, it is desirable to have the capability to employ such a system to perform high quality graphics processing. However, it is likewise noted that the claimed subject matter is not limited to high quality graphics. For example, as will become clear, an embodiment of the claimed subject matter may prove advantageous in connection with computer games and/or other lower end applications.

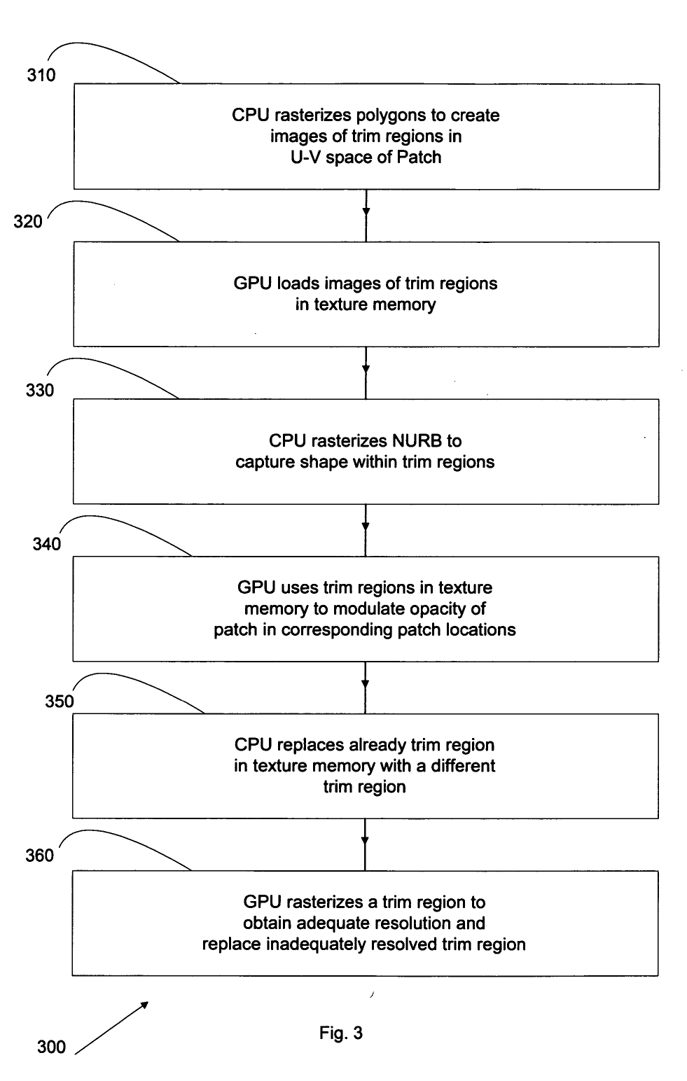

FIG. 3 is a flowchart illustrating an embodiment of a method of trimming three dimensional surfaces, such as a non-uniform rational B-spline, previously referred to as a NURB, using dedicated graphics hardware. It is noted, of course, that the claimed subject matter is not limited in scope to performing a method embodiment in the particular order shown in FIG. 3. Thus, method embodiments within the scope of the claimed subject matter may include different orders, additional aspects, and/or different aspects than the embodiment specifically illustrated in FIG. 3.

As previously suggested and as shall be discussed in more detail, in this particular embodiment, a three-dimensional (3D) surface is rasterized using dedicated graphics hardware. Likewise, one or more trim regions are rasterized in a parametric space of the particular surface. These trim regions are loaded in texture memory of the dedicated graphics hardware, such as memory 540 illustrated in FIG. 5. Portions of the rasterized 3D surface are then modified based at least in part on the one or more trim regions. It is noted that while, in this particular embodiment, the surface comprises a NURB, the claimed subject matter is not limited in scope in this respect. Likewise, although, in this particular embodiment dedicated graphics hardware comprises a programmable floating point GPU, this is merely an example embodiment and any other programmable GPU currently in existence or later developed may alternatively be employed.

Although the claimed subject matter is not limited in scope to method embodiment 300 illustrated in FIG. 3, it is further noted that the forgoing processing is performed entirely on dedicated graphics hardware without direct CPU support. Thus, rasterizing the 3D surface, rasterizing and loading the trim region or regions, and trimming the 3D surface take place on GPU 210 in this particular embodiment.

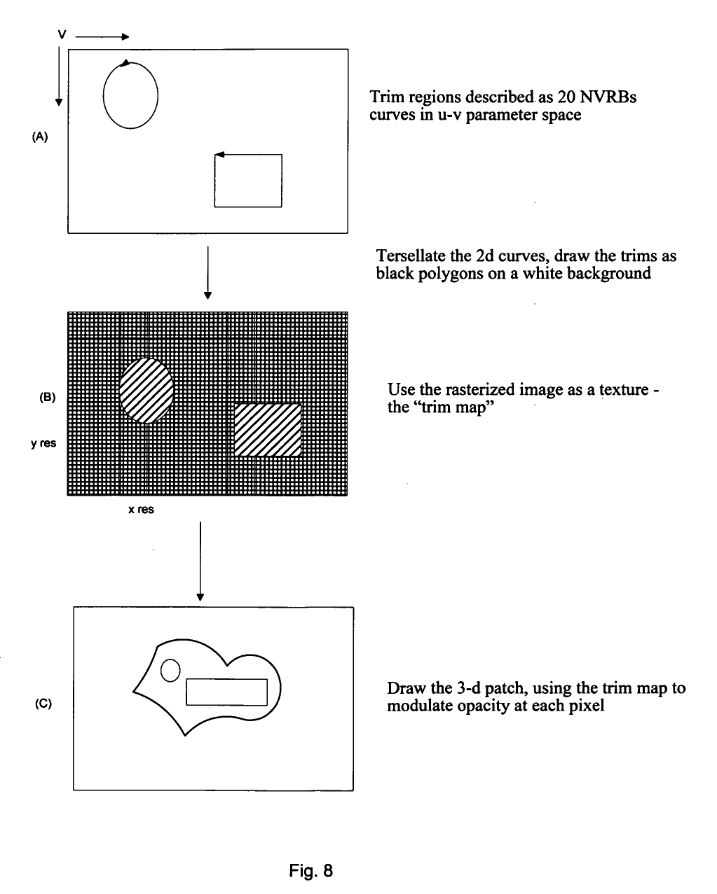

Referring now to block 310 of FIG. 3, GPU 210, in this particular embodiment, rasterizes polygons to create an image of one or more trim regions in “u-v” parametric space for the patch or 3D surface to be modified. In this context, the terms patch, surface, and/or 3D surface are used interchangeably throughout the specification and claims. FIG. 8 is a schematic diagram depicting this particular embodiment as the patches or surfaces are process. Therefore, subfigure (a) of FIG. 8 conceptually illustrates the trim regions described as two-dimensional NURBS curves in u-v parametric space. Referring now to FIG. 3, as illustrated at block 320, the GPU loads the image of the one or more trim regions that have been created into texture memory of the dedicated graphics hardware. At block 330, GPU 210 rasterizes the patch, in this particular embodiment, an NURB, tessellating to capture its shape without the trim regions, that is, before any modifying or trimming of the patch has taken place. Thus, as illustrated at subfigure (b) of FIG. 8, the two-dimensional curves are tessellated. For example, the trim regions may be drawn as black polygons on white background, although, of course, the claimed subject matter is not limited in scope in this respect. For example, in alternative embodiments, a particular foreground color may be employed to indicate pixels inside the trim region, and a particular background color may be employed to indicate pixels outside the trim region.

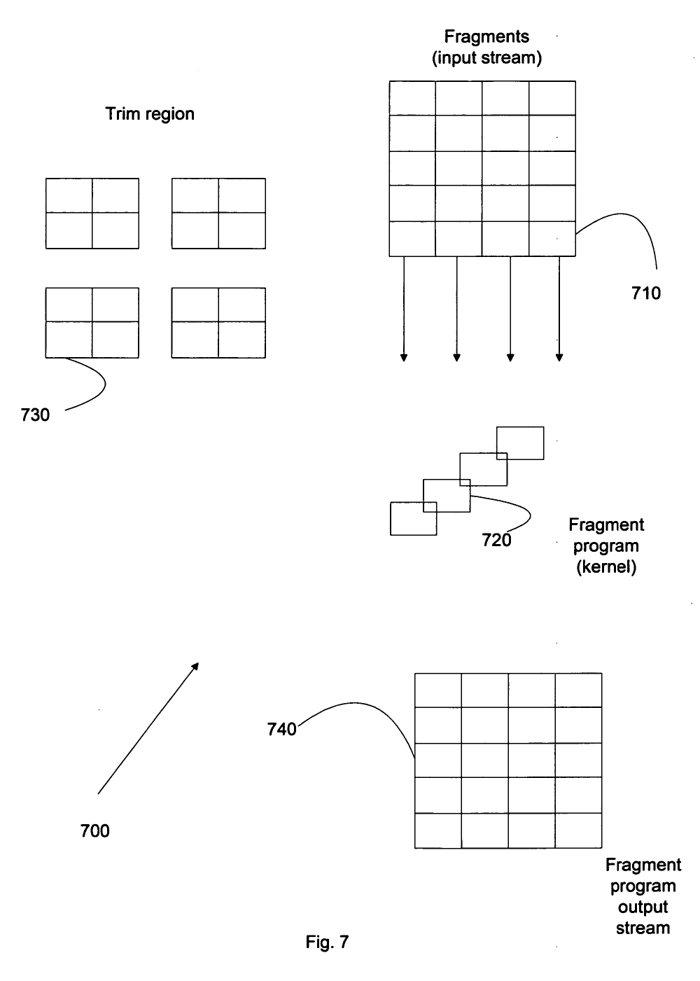

At block 340, GPU 210 then uses the one or more trim regions, contained in texture memory, to trim portions of the rasterized surface or patch. In one particular embodiment, although the claimed subject matter is not limited in scope in this respect, the GPU may employ fragment shading, e.g., a technique to produce shading via a fragment program, to modulate alpha and/or color at least in part based upon the loaded one or more trim regions. Fragment shading by the GPU is illustrated for this particular embodiment schematically in FIG. 7. Here, following rasterization of a surface, fragments are applied as an input stream to fragment processing stage 180, previously described. Referring to FIG. 7, input stream 710 is applied to fragment program or kernel 720. In particular, in this embodiment, the fragments of the input stream are modified based at least in part on the one or more trim regions 730 loaded in texture memory. For example, in one embodiment, the opacity of the rasterized surface is modulated so that the portions of the rasterized surface that correspond to one or more of the trim regions will appear transparent when displayed. This is illustrated in FIG. 7 as fragment program output stream 740.

Thus, the opacity or transparency of the patch may be modulated, for example, at corresponding patch locations based at least in part on the trim regions. Of course, the claimed subject matter is not limited in scope to this particular approach. For example, in alternative embodiments, rather than modulating opacity, for example, instead, the appropriate pixel values may be discarded or otherwise processed by the fragment stage so that the trim regions portions of the patch will no longer be visibly apparent when the object is displayed, thereby producing a trimmed surface. For example, the fragment program may “kill” the fragment if appropriate portions of the one or more trim regions have corresponding patch locations in the rasterization of the surface. Of course, in alternative embodiments within the scope of the claimed subject matter, the surface may also be modified in a manner so that the trim region portions of the patch remain at least partially visible. The resulting three-deimensional patch using the trim regions to modulate opacity, for this particular embodiment, is illustrated conceptually at subfigure (c) of FIG. 8.

Referring again to FIG. 3, as illustrated by block 350, it is noted that, for this particular embodiment, a plurality of trim regions may be loaded and employed in the manner just described. Thus, a particular trim region may be produced once and stored rather than regenerated again when additional use again becomes convenient. However, if a trim region is desired that has not previously been rasterized, that trim region may be rasterized, such as in the manner previously described, and it may then replace one of the currently loaded trim regions in texture memory, or elsewhere if, in an alternative embodiment, the trim regions are not maintained in texture memory. Likewise, for those situations in which one of the trim regions that has been loaded in texture memory, for example, does not provide sufficiently fine resolution, in an alternative embodiment, that trim region may be rerasterized with a finer resolution. The rerasterized trim regions may then, in one embodiment, replace the previously rasterized trim region. Of course, more than one trim region may be rerasterized in an alternative embodiment and it is not necessary that the rerasterized trim region replace the trim regions of insufficient resolution. This is merely one example embodiment. Many other approaches are possible and are included within the scope of the claimed subject matter. For example, the trim regions may be stored elsewhere, such as, in the instance in which a graphics card is employed, in a separate cache memory other than texture memory. The trim regions, in such an embodiment, may then be loaded from the separate cache memory, as appropriate, during GPU operation.

Although the claimed subject matter is not limited in scope in this respect, one approach to determining whether a resolution is sufficiently fine for rasterizing a trim region in the u-v parameter space of the patch or surface may be based, at least in part, on the size of the patch when rasterized on a display. It may be desirable, for example, to choose a resolution sufficiently fine so that texels in the trim region will have a sub-pixel size when displayed. Although the claimed subject matter is not limited in scope in this respect, such an approach is similar to the choice of tessellation rates, for example, employed in Reyes-like rendering. See, for example, “The Reyes Image Rendering Architecture,” by R. L. Cook, L. Carpender, and E. Catmull, SIGGRAPH 87, 95-102.

Although the claimed subject matter is not limited in scope to this particular embodiment, it has the potential to provide a number of advantages. As previously discussed, in one potential embodiment, resolution for one or more trim regions may be adjusted. Adjusting resolution allows quality graphics to be achieved. Additionally, the previously described embodiment is fast when compared with alternate approaches. Therefore, in addition to improving quality, such an approach may be suitable for real time processing, such as for computer graphics and/or computer games, as previously indicated. As was suggested, graphics pipelines have been developed to have the ability to quickly and efficiently perform particular types of computations and calculations. Such computations and calculations include the rasterization of trim regions previously described. By way of contrast, if a CPU, rather than a GPU, were to attempt these types of computations, it would likely be more time consuming. Thus, in this particular embodiment, the ability of a GPU to rasterize curves and/or lines, and perform additional filtering, shading and the like quickly and efficiently has, in this context, been leveraged. Furthermore, the approach of this particular embodiment, previously discussed, in which a patch or surface is rendered without trim regions allows a high quality representation of the patch to be rendered quickly and efficiently before attempting modification of the surface. In contrast, other approaches involving tessellation of the trim regions via the CPU are likely to degrade quality and speed. Of course, while these may be particular advantages, as previously indicated, the claimed subject matter is not limited in scope to this embodiment or to any particular embodiment. Likewise, therefore, the claimed subject matter is not limit to achieving these particular advantages.

It is, of course, now appreciated, based at least in part on the foregoing disclosure, that software may be produced capable of producing the desired graphics processing. It will, of course, also be understood that, although particular embodiments have just been described, the claimed subject matter is not limited in scope to a particular embodiment or implementation. For example, one embodiment may be in hardware, such as implemented to operate on a device or combination of devices as previously described, for example, whereas another embodiment may be in software. Likewise, an embodiment may be implemented in firmware, or with any combination of hardware, software, and/or firmware, for example. Likewise, although the claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, a computing platform, a GPU, a CPU, another device or system, or combinations thereof, for example, may result in an embodiment of a method in accordance with the claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, the claimed subject matter is not limited in scope to this example.

In the preceding description, various aspects of the claimed subject matter have been described. For purposes of explanation, specific numbers, systems and/or configurations were set forth to provide a thorough understanding of the claimed subject matter. However, it should be apparent to one skilled in the art having the benefit of this disclosure that the claimed subject matter may be practiced without the specific details. In other instances, well-known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of the claimed subject matter.

1. A method of modifying a rasterized surface using dedicated graphics hardware comprising:
loading in texture memory one or more trim regions in a parameter space of said surface;
rasterizing a surface using said dedicated graphics hardware;
modifying portions of said rasterized surface based at least in part on said one or more trim regions.

2. The method of claim 1, wherein said surface comprises an NURB.

3. The method of claim 1, wherein said dedicated graphics hardware comprises a programmable GPU.

4. The method of claim 1, wherein said modifying portions of said rasterized surface comprises trimming said portions.

6. The method of claim 4, wherein said trimming comprises modulating the opacity of said portions so that said portions are not visible when displayed.

7. The method of claim 1, wherein said rasterizing said surface comprises tessellating said surface.

8. The method of claim 1, wherein said texture memory has loaded a plurality of distinct trim regions; and
wherein said modifying portions of said rasterized surface comprises modifying said portions based at least in part on said plurality of trim regions.

9. The method of claim 8, wherein said modifying portions of said rasterized surface comprises modifying the opacity of said portions based at least in part on said plurality of trim regions.

10. The method of claim 8, and further comprising replacing in said texture memory at least one of said trim regions with another trim region to be employed to modify said portions.

11. The method of claim 8, and further comprising replacing in said texture memory at least one of said trim regions with a trim region having a finer resolution.

12. The method of claim 11, wherein the resolution of said finer resolution trim region is such that texels of said finer resolution trim region are sub-pixel-sized.

13. The method of claim 11, wherein said at least one of said trim regions of not sufficiently fine resolution is replaced with a corresponding trim region rerasterized to a sufficiently fine resolution.

14. A method of modifying a rasterized surface using dedicated graphics hardware comprising:
processing in texture memory one or more trim regions in the parametric space of said surface so that an image is formed having texels corresponding to parametric locations on said surface, wherein the color value of said texels indicates whether that parametric position is inside or outside said trim regions;
rasterizing said surface using dedicated graphics hardware; and
modifying the rasterization of said surface on a pixel-by-pixel basis based at least in part on said texels representing said trim regions.

15. The method of claim 14, wherein said surface comprises an NURB.

16. The method of claim 14, wherein said dedicated graphics hardware comprises a programmable GPU.

17. The method of claim 4, wherein said modifying the rasterization comprises modulating the opacity of pixels of said rasterization so that portions are not visible when displayed.

18. An article comprising: a storage medium having stored thereon instructions, that, when executed, result in performance of a method of modifying a rasterized surface as follows:
loading in texture memory one or more trim regions in a parameter space of said surface;
rasterizing a surface using dedicated graphics hardware; and
modifying portions of said rasterized surface based at least in part on said one or more trim regions.

19. The article of claim 18, wherein said instructions, when executed, further result in:
said surface comprising an NURB.

20. The article of claim 18, wherein said dedicated graphics hardware comprises a programmable GPU.

21. The article of claim 18, wherein said instructions, when executed, further result in:
said modifying portions of said rasterized surface comprising trimming said portions.

22. The article of claim 21, wherein said instructions, when executed, further result in: said trimming comprises modulating the opacity of said portions so that said portions are not visible when displayed.

23. The article of claim 18, wherein said instructions, when executed, further result in: said rasterizing said surface comprising tessellating said surface.

24. The article of claim 18, wherein said instructions, when executed, further result in: said texture memory having loaded a plurality of distinct trim regions; and said modifying portions of said rasterized surface comprising modifying said portions based at least in part on said plurality of trim regions.

25. The article of claim 24, wherein said instructions, when executed, further result in: said modifying portions of said rasterized surface comprising modifying the opacity of said portions based at least in part on said plurality of trim regions.

26. The article of claim 24, wherein said instructions, when executed, further result in: replacing in said texture memory at least one of said trim regions with another trim region to be employed to modify said portions.

27. The article of claim 24, wherein said instructions, when executed, further result in: replacing in said texture memory at least one of said trim regions with a trim region having a finer resolution.

28. The article of claim 27, wherein said instructions, when executed, further result in: the resolution of said finer resolution trim region being such that texels of said finer resolution trim region are sub-pixel-sized.

29. The article of claim 27, wherein said instructions, when executed, further result in:
said at least one of said trim regions of not sufficiently fine resolution being replaced with a corresponding trim region rerasterized to a sufficiently fine resolution.

20. An apparatus comprising: a graphics pipeline;
said graphics pipeline being adapted to rasterize a 3D surface and to modify portions of said rasterized surface based at least in part on one or more trim regions loaded in texture memory.

31. The apparatus of claim 30, wherein said graphics pipeline is incorporated in a programmable GPU.

32. The apparatus of claim 31, wherein said 3D surface comprises an NURB.

33. The apparatus of claim 31, wherein said graphics pipeline is adapted to modify portions of said rasterized surface by trimming said portions.

34. The apparatus of claim 33, wherein said graphics pipeline is adapted to trim said portions by modulating the opacity of said portions so that said portions are not visible when displayed.

35. The apparatus of claim 31, wherein said graphics pipeline is adapted to rasterize said surface by tessellating said surface.

36. The apparatus of claim 31, wherein said graphics pipeline is adapted to load a plurality of distinct trim regions in texture memory; and
wherein said graphics pipeline is adapted to modify portions of said rasterized surface by modifying said portions based at least in part on said plurality of trim regions.

37. The apparatus of claim 36, wherein said graphics pipeline is adapted to modify portions of said rasterized surface by modifying the opacity of said portions based at least in part on said plurality of trim regions.

38. The apparatus of claim 36, wherein said graphics pipeline is further adapted to replace in said texture memory at least one of said trim regions with another trim region to be employed to modify said portions.

39. The apparatus of claim 36, wherein said graphics pipeline is further adapted to replace in said texture memory at least one of said trim regions with a trim region having a finer resolution.

40. The apparatus of claim 31, wherein said programmable GPU is incorporated in at least one of the following systems: a desktop computer, a mobile computer, a game console, a hand-held device, a wireless communications device, a networked device, a display system, a motherboard, a graphics card, and an integrated circuit chip.

41. An apparatus comprising:
a first means for processing coupled to a second means for processing, said second means for processing comprising a means for graphical processing;
said second means for graphical processing further being adapted to rasterize a 3D surface and to modify portions of said rasterized surface based at least in part on one or more trim regions loaded in a texture memory of said second means for graphical processing.

42. The apparatus of claim 41, wherein said first means for processing comprises a CPU.

43. The apparatus of claim 41, wherein said first means for processing and said second means for processing are coupled via a bus.

44. The apparatus of claim 41, wherein said second means for graphical processing comprises a programmable GPU.

45. The apparatus of claim 44, wherein said programmable GPU is incorporated in at least one of the following systems: a desktop computer, a mobile computer, a game console, a hand-held device, a wireless communications device, a networked device, a display system, a motherboard, a graphics card, and an integrated circuit chip.

46. A video frame comprising: a plurality of video frame pixel values;
at least some of said video frame pixel values having been processed by rasterizing a surface using dedicated graphics hardware, loading in texture memory one or more trim regions in a parameter space of said surface, and modifying portions of said rasterized surface based at least in part on said one or more trim regions.

47. The video frame of claim 46, wherein said surface comprises an NURB.

48. The video frame of claim 46, wherein said dedicated graphics hardware comprises a programmable GPU.

49. The video frame of claim 46, wherein said modifying portions of said rasterized surface comprises trimming said portions.

50. The video frame of claim 49, wherein said trimming comprises modulating the opacity of said portions so that said portions are not visible when displayed.

51. The video frame of claim 46, wherein said rasterizing said surface comprises tessellating said surface.

52. The video frame of claim 46, wherein said modifying portions of said rasterized surface comprises modifying said portions based at least in part on a plurality of trim regions loaded in said texture memory.

53. The video frame of claim 52, wherein said modifying portions of said rasterized surface comprises modifying the opacity of said portions based at least in part on said plurality of trim regions.
